(19) United States
(12) Patent Application Publication
(10) Pub. No.: US 2013/0206109 A1
(43) Pub. Date: Aug. 15, 2013

(54) METHOD FOR THE OPEN-LOOP CONTROL AND CLOSED-LOOP CONTROL OF AN INTERNAL COMBUSTION ENGINE

(71) Applicant: MTU Friedrichshafen GmbH, (US)

(72) Inventors: Armin Dölker, Friedrichshafen (DE); Marc Mauritz, Ravenburg (DE)

(73) Assignee: MTU Friedrichshafen GmbH, Friedrichshafen (DE)

(21) Appl. No.: 13/754,651

(22) Filed: Jan. 30, 2013

(30) Foreign Application Priority Data
Jan. 30, 2012 (DE) 10 2012 005 621.4
Apr. 27, 2012 (DE) 10 2012 008 538.9

(51) Int. Cl. F02M 69/50

(52) U.S. Cl. CPC F02M 69/50
USPC 123/456

(57) ABSTRACT

A method for closed-loop control and open-loop control of an internal combustion engine having a common rail system is closed. In the proposed method, the rail pressure (pCR) is determined in that an electronic engine control unit specifies the flow rate of a high-pressure pump into the rail via an intake throttle on the low-pressure side. An intake throttle actuation function, by which the intake throttle is temporarily actuated, is set to recur over time in the case of known idle time of the internal combustion engine and an actuated engine control unit.

### TECHNICAL FIELD

The disclosure relates to a method for an open-loop control and closed-loop control of an internal combustion engine.

### BACKGROUND

In the case of an internal combustion engine having a common rail system, the quality of the combustion is essentially determined via the pressure level in the rail. Therefore, the rail pressure is controlled in order to maintain the legal emission threshold values. A rail pressure control loop typically comprises a comparison point for determining a control deviation, a pressure regulator for calculating a control signal, a closed-loop control system, and a software filter for calculating the actual rail pressure in the feedback branch. The control deviation is calculated from the difference of the target rail pressure and the actual rail pressure. The closed-loop control system comprises the pressure control member, the rail, and the injectors for injecting the fuel into the combustion chambers of the internal combustion engine.

A corresponding common rail system with pressure control is for known, for example, from DE 10 2006 040 441 B3, in which the pressure regulator accesses an intake throttle on the lower pressure side via the control signal. The intake cross-section to the high-pressure pump, and thus the fuel volume supplied, is determined, in turn, via the intake throttle. The intake throttle is actuated in negative logic, which means that it is completely open at a current value of zero amperes. A passive pressure relief valve is provided as a safeguard against a rail pressure that is too high, for example after a cable break in the power supply to the intake throttle. If the rail pressure exceeds a critical value, for example 2400 bar, then the pressure relief valve opens. The fuel from the rail is diverted into the fuel tank via the open pressure relief valve.

In general, an internal combustion engine is assembled by the manufacturer on a final inspection test bench, removed after approval, packaged, and shipped to the customer, which in turn can take several weeks. This long idle time can lead to the event that the intake throttle is gummed up with fuel and therefore does not react to the control signal of the electronic engine control unit at engine start. In practice, this same problem also occurs with respect to a quick start standby generator unit (emergency generator unit), in which the internal combustion engine is stopped for a longer period, e.g., two weeks, and is then started. A sticky intake throttle can lead to the event that the rail pressure increases for so long at engine start that the pressure relief valve opens. The consequence would be a target/actual deviation of the rail pressure, which has a negative influence on the emission values and the output of the internal combustion engine.

### SUMMARY

What is needed is a safe engine start after a longer idle time for an internal combustion engine having a common rail system.

One exemplary method is presented in which an intake throttle actuation function is set to recur over time in the case of known idle time of the internal combustion engine and an actuated engine control unit. By means of the intake throttle actuation function, the intake throttle is temporarily actuated, for example for one second, in the closed direction. The intake throttle actuation function is set for the first time in the initialization phase of the engine control unit. Afterwards, the intake throttle is actuated at an interval of, for example, fourteen days. In this manner, the application case is covered where the internal combustion engine is put into operation for the first time after a longer idle time as well as the application case where the internal combustion engine is used as a quick start standby generator unit. It is thus advantageous that a stickiness of the intake throttle is prevented or an already seized intake throttle is made viable. In this manner, an optimal engine start with correct rail pressure, correct emissions values, and correct output of the internal combustion engine is guaranteed. Likewise, an undesired reaction of the passive pressure relief valve is prevented.

Since the intake throttle is open when lacking power, due to safety reasons, the actuation function sets either the PWM signal for controlling the intake throttle to a PWM actuation value, or an electrical target current to an electrical actuation current. At the same time, the periodic time of the PWM signal is set to an actuation value. In practice, the actuation value is selected so low that the intake throttle is induced to vibrations, by which means the intake throttle is effectively vibrated loose. The actuation function is interrupted when the internal combustion engine is started. An engine start is detected whenever the engine rotational speed is greater than a rotational speed threshold, for example 80 revolutions per minute, or an injection is activated.

The method is applicable for an internal combustion engine which activates idle state from normal operation, as well as for an internal combustion engine that activates idle state from emergency operation. An emergency operation is present when a defective rail pressure sensor is detected. A corresponding method is known, for example, from DE 10 2009 050 468 A1. The method is likewise applicable for an internal combustion engine in a V arrangement, in which an independent common rail system is present on the A-side and an independent common rail system is present on the B-side. The universal applicability of the method is therefore advantageous.

### BRIEF DESCRIPTION OF THE DRAWINGS

An exemplary embodiment is presented in the figures wherein:

FIG. 1 shows a system schematic;

FIG. 2 shows a reduced rail pressure control loop in a first embodiment;

FIG. 3 shows a reduced rail pressure control loop in a second embodiment;

FIG. 4 shows a state transition diagram;

FIG. 5A shows a timing diagram of an engine rotational speed;

FIG. 5B shows a timing diagram of an engine idle signal;

FIG. 5C shows a timing diagram of an actuation current;

FIG. 5D shows a timing diagram of a period of time of a pulse-width modulation signal;

FIG. 5E shows a timing diagram of a state of the transition diagram;

FIG. 5F shows a timing diagram of the state of an intake actuation function;;

FIG. 6 shows a program flow chart;

FIG. 7 shows a first subroutine; and

FIG. 8 shows a second subroutine.

### DETAILED DESCRIPTION

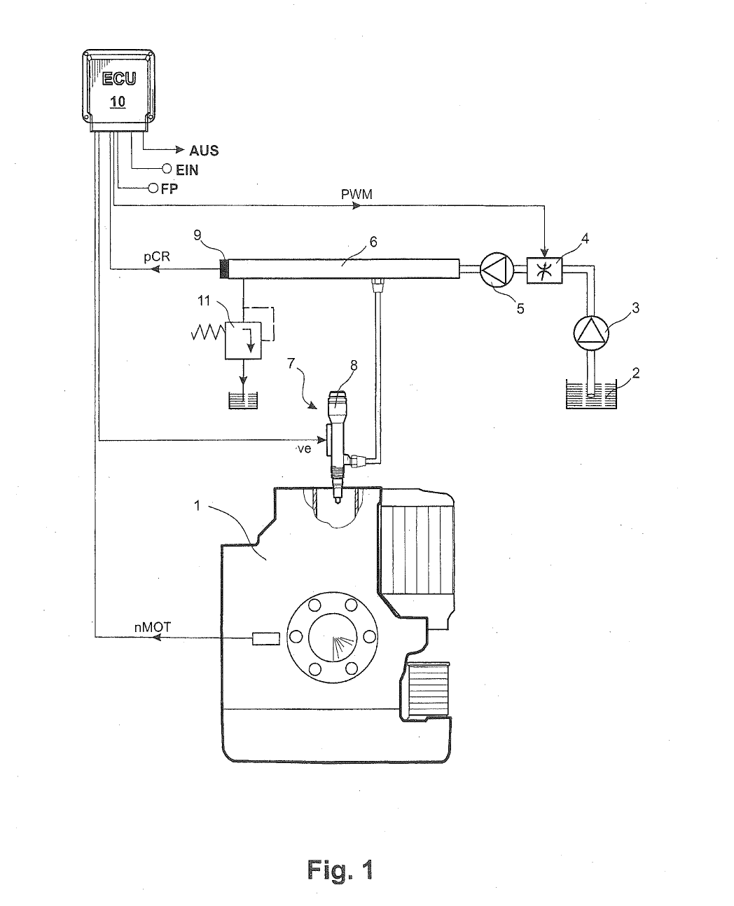

FIG. 1 shows a system schematic of an electronically controlled internal combustion engine 1 with a common rail system. The common rail system comprises the following mechanical components: a low-pressure pump 3 for supplying fuel from a fuel tank 2, an adjustable intake throttle 4 for influencing the through flowing volumetric flow rate of the fuel, a high-pressure pump 5 for supplying the fuel under increased pressure, a rail 6 for accumulating the fuel, and injectors 7 for injecting the fuel into the combustion chambers of the internal combustion engine 1. The common rail system can also optionally be equipped with individual accumulators, wherein then, for example, an individual accumulator 8 is integrated in injector 7 as an additional buffer volume. A passive pressure relief valve 11 is provided to protect from an incorrectly high pressure level in the rail 6, which pressure relief valve opens, for example, at a rail pressure of 2400 bar and in the opened state diverts the fuel out of the rail 6 into the fuel tank 2.

The operational mode of the internal combustion engine 1 is determined by an electronic engine control unit (ECU) 10. The engine control unit 10 includes the conventional components of a microcomputer system, for example a microprocessor, I/O modules, buffer, and memory components (EEPROM, RAM). The relevant operating data for operating the internal combustion engine 1 are administered in characteristic maps/characteristic curves in the memory components. In this manner, the engine control unit 10 calculates the output variables from the input variables. FIG. 1 presents as an example the following input variables: the rail pressure pCR, which is measured by a rail pressure sensor 9, an engine rotational speed nMOT, an FP signal for performance targets by the operator, and an input variable EIN. The additional sensor signals are combined under the input variable EIN, for example the charge air pressure of an exhaust turbocharger. In FIG. 1, a pulse width modulating (PWM) signal for controlling the intake throttle 4, a ve signal for controlling the injectors 7 (injection start/injection end), and an output variable AUS are shown as output variables of the engine control unit 10. The output variable AUS stands in place of the additional control signals for the open-loop control and the closed-loop control of the internal combustion engine 1, for example for a control signal for actuating a second exhaust turbocharger during sequential turbocharging.

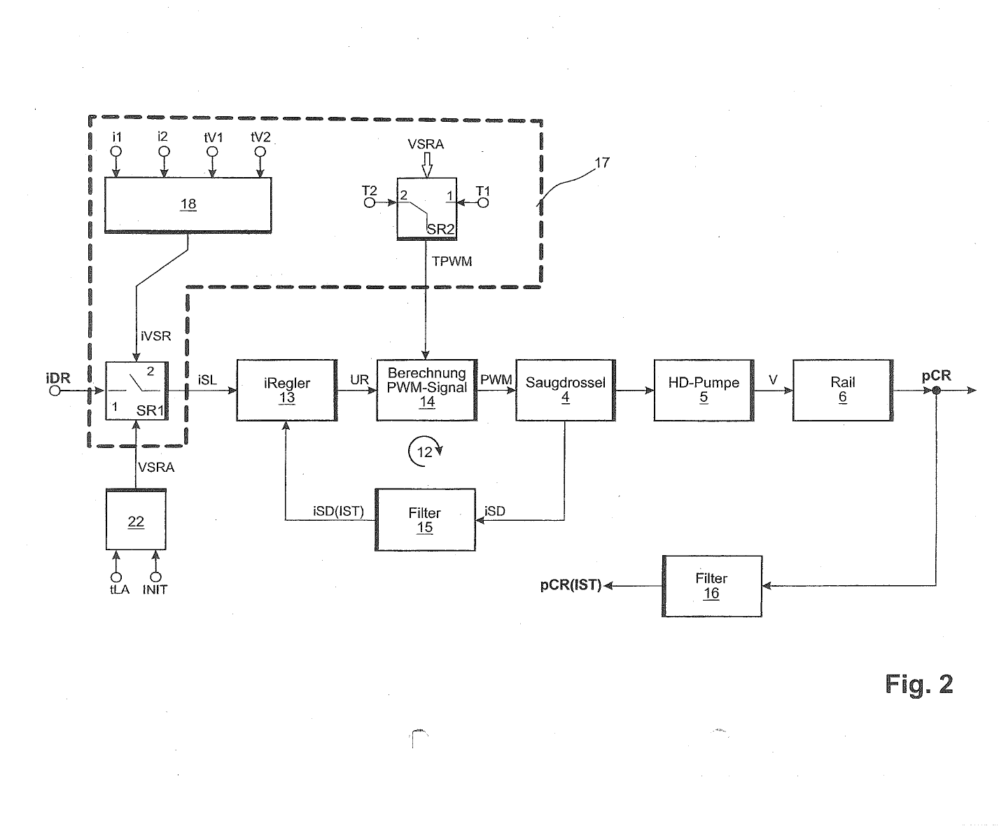

FIG. 2 shows a rail pressure control loop in a reduced representation with the function blocks of the disclosure in a first embodiment. The embodiment presented shows the intake throttle actuation function 17 by which a target current is predefined in two steps. A complete rail pressure control loop with subordinate current control loop for the intake throttle is known from DE 10 2009 050 468 A1, the contents of which are incorporated by reference in its entirety and to which reference is made here. FIG. 2 shows the following, known from the rail pressure control loop from DE 10 2009 050 468 A1: the current control loop 12, the high-pressure pump 5, the rail 6, and the filter 16 for calculating the actual rail pressure pCR(IST). This is supplemented by the intake throttle actuation function 17. A first switch SR1, a second switch SR2, and a function block 18 are combined in the intake throttle actuation function 17. The input variables for the representation in FIG. 2 are the electronic pressure regulator current iDR which is calculated depending on the rail pressure control deviation by the rail pressure regulator (not shown), and an actuation signal VSRA. The output variables are the raw values of the rail pressure pCR which are detected by the rail pressure sensor (FIG. 1: 9). The current control loop 12 comprises the following elements: a filter 15 in the feedback branch for calculating the intake throttle actual current iSD(IST) from the electrical current iSD measured for the intake throttle 4, a current regulator 13 for calculating a closed loop voltage UR on the basis of the control deviation of the current—in this case, intake throttle actual current iSD(IST) compared with the target current iSL, a PWM calculation 14, and the intake throttle 4 as the closed loop control system.

The further description initially occurs for normal operation. In normal operation, the switches SR1 and SR2 are in position 1. If switch SR1 is in position 1, the target current iSL corresponds to the pressure regulator current iDR. The pressure regulator 13 calculates a control deviation by the deviation of the target current iSL compared to the actual current of the intake throttle iSD(IST), and determines the control variable therefrom, in this case the closed loop voltage UR. The closed loop voltage UR is converted into a PWM signal PWM via the PWM calculation 14. Since the second switch SR2 is located in the position 1, the PWM signal PWM has the periodic time TPWM which in turn corresponds with the periodic time T1. The intake throttle is then impinged using the PWM signal PWM, by which the path of the magnetic core of the intake throttle is adjusted and the delivery rate of the high-pressure pump is freely influenced. For safety reasons, the intake throttle is open when without power and is impinged in the direction of the closed position via the PWM signal. The output variable of the intake throttle is then the volume flow V actually supplied from the high-pressure pump 5 into the rail 6. The pressure level pCR in the rail 6 is detected via the rail pressure sensor. The actual rail pressure pCR(IST) is then calculated from these raw values of the rail pressure pCR via the filter 16. In this manner, the rail pressure control loop is closed.

If a defective rail sensor is detected in normal operation, then emergency operation activates. In emergency operation, the rail pressure is directed in that the pressure regulator current iDR is constantly stated. Since in this case the intake throttle is completely open, the rail pressure pCR rises incrementally until the passive pressure relief valve (FIG. 1: 11) responds. In the open state, the fuel is diverted from the rail into the fuel tank.

If an idle time of the internal combustion engine is detected and if a time period tLA, for example tLA=2 weeks, is expired, then a signal VSRA=1 is set by a function block 22. As a result of this, the two switches, SR1 and SR2, switch into position 2. From now on, the intake throttle actuation function 17 is decisive for the current regulator 13 and the periodic time TPWM of the PWM signal PWM. An actuation current iVSR is now temporarily emitted via the function block 18. The actuation current iVSR initially corresponds to a first current value i1, for example i1=0.5 A. The first current value i1 is emitted for a first interval tV1, for example tV1=1 s. This corresponds to the first current level. After expiration of the first interval tV1, the function block 18 sets the actuation current iVSR to a second current value i2, for example i2=1 A, for a second interval tV2, for example tV2=2 s. This corresponds to the second current level. During the two times tV1 and tV2, the periodic time TPWM of the PWM signal is identical to the periodic time T2, which is also designated as the actuation time later in the text. The actuation time T2 is thereby selected such that the intake throttle is induced to oscillations, essentially vibrating free. A typical value for the periodic time T2 is T2=20 ms.

The signal VSRA is likewise set to a value of one in the initialization phase INIT of the engine control unit such that the target current iSL is defined in two steps by the intake throttle actuation function 17 in correspondence with the previously cited example. This application then arises if the internal combustion engine is activated for the first time by the end customer.

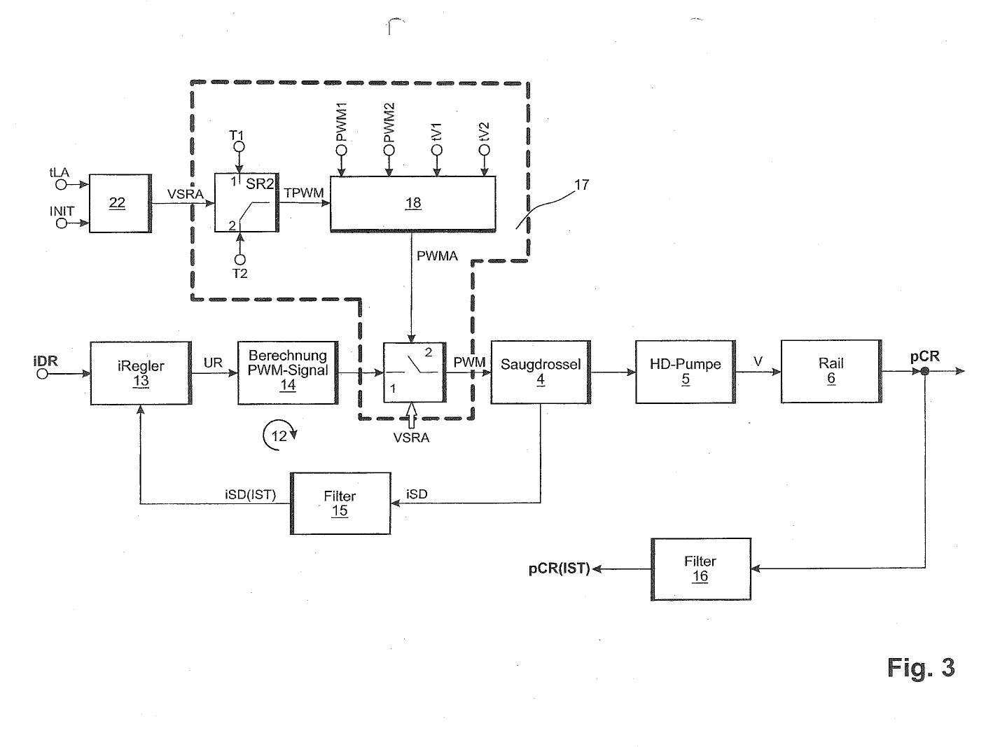

FIG. 3 shows a rail pressure control loop in a reduced representation in a second embodiment with the function blocks for the disclosure. For this embodiment, a PWM actuation value PWMA is emitted to the intake throttle 4 via the intake throttle actuation function 17. The PWM actuation value PWMA is thereby implemented in two steps. For example, in the form of a first PWM value PWM1 for the interval tV1=1 s and a second PWM value PWM2 for the interval tV2=2 s. The further functionality corresponds to the description of FIG. 2.

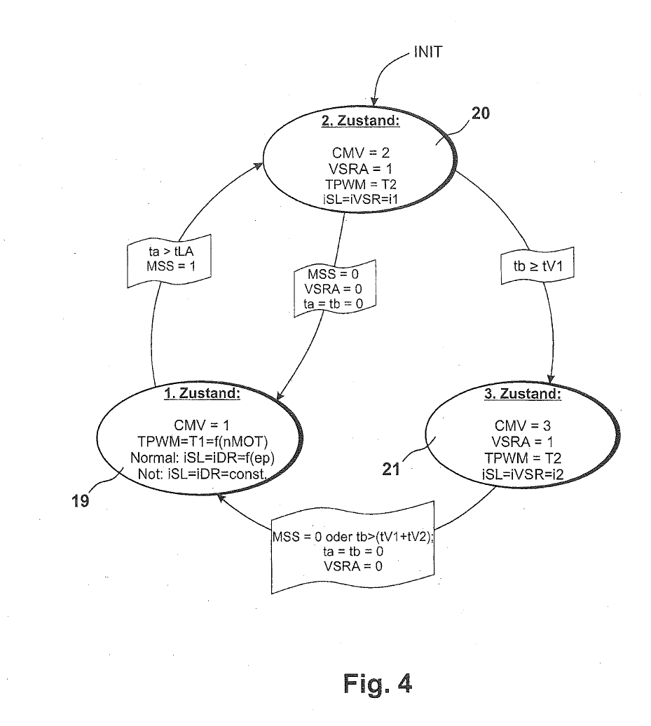

FIG. 4 represents the method in the form of a state transition diagram. The diagram shows a total of three states, wherein the individual states are characterized by the variable CMV. Directly after switching on the engine control unit in the initialization phase INIT, the intake throttle actuation function—that is, the vibrating free of the intake throttle—is set. For this reason, the second state 20 of the transition diagram is set. Thus CMV=2 applies. At a set intake throttle actuation function, the actuation current iVSR is set to a first current value i1, for example i1=0.5 A. Based on the switch SR1, see FIG. 2, the target current iSL corresponds to the actuating current iVSR and thus to the first current value i1. Supplementally, the periodic time TPWM of the PWM signal is set to the value TPWM=T2, for example actuation time T2=20 ms. A VSRA variable, which indicates whether the intake throttle actuation function is set, is set to the value VSRA=1. If the first interval tV1 is expired (tb>tV1), then the third state 21 is activated. CMV=3 thus applies. From now on, the actuation current iVSR is set to a second current value i2, for example i2=1 A, via the intake throttle actuation function. The periodic time of the PWM signal remains unchanged at the value T2. The VSRA variable remains at the value 1, i.e., the intake throttle actuation function remains set. If at this point in addition the second interval tV2 is expired or a running internal combustion engine (MSS=0) is detected, then the intake throttle actuation function is ended, i.e., the first state 19 is activated and the VSRA variable as well as the times ta and tb are reset. If, in the first state 19, an error-free internal combustion engine is detected, then normal operation is set. In normal operation, the target current iSL corresponds to the pressure regulator current iDR, which in turn is calculated depending on the rail pressure control deviation ep via a rail pressure regulator, typically a PIDT1 regulator. The periodic time TPWM of the PWM signal is set to the periodic time T1 which is calculated depending on the engine rotational speed nMOT. If, in contrast, in the first state a defective rail pressure sensor is detected, then the emergency operation is set. In emergency operation, the pressure regulator current iDR is defined as a constant. If, in a first state 19, a stable idle time of the internal combustion engine is detected (MSS=1), then the time ta starts up. A stable idle time is then present if the engine rotational speed is steadily lower than a rotational speed threshold, for example 80 rotations/minute for a predefined time. If ta reaches the time period tLA, for example tLA=2 weeks, then the intake throttle actuation function is actuated again, i.e., the second state 20 is activated. If the second state 20 is active and a running internal combustion engine (MSS=0) is detected, then the first state 19 is activated from the second state 20, wherein the VSRA variable and the time variables ta and tb are reset.

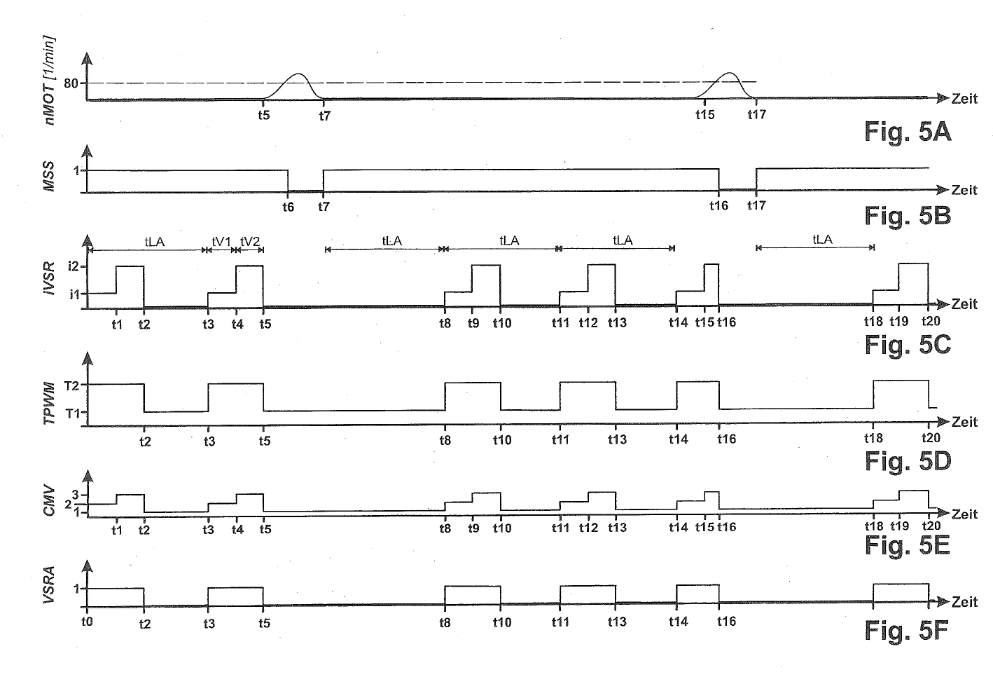

FIG. 5 represents the method in a timing diagram. FIG. 5 consists of the partial FIGS. 5A to 5F. These show the engine rotational speed nMOT (FIG. 5A), the engine idle signal MSS (FIG. 5B), the actuation current iVSR (FIG. 5C), the periodic time TPWM of the PWM signal (FIG. 5D), the CMV state of the transition diagram (FIG. 5E) and the state of the intake throttle actuation function VSRA (FIG. 5F). A two-step embodiment of the actuation current iVSR is presented, wherein the target current iSL, thus the input variable of the current regulator, corresponds to the actuation current iVSR (iSL=iVSR).

At time t0, the electronic engine control unit is switched on, which additionally leads to the event that the intake throttle actuation function VSRA=1 is set. This means that the actuation current iVSR is set to the value i1 during the interval tV1, thus at time t1. The periodic time TPWM of the PWM signal is set to the actuation value T2, the CMV state assumes the value CMV=2. At time t1, the actuation current iVSR, and thus the target current iSL, is set to the value i2 and the CMV state changes to the value CMV=3. At time t2, the interval tV2 is expired, by which means the actuation current iVSR is reset again to the value iVSR=0 A, since the internal combustion engine is still stopped, i.e., in FIG. 5B MSS=1 applies. The periodic time TPWM is reset to the base periodic time T1, which applies to a stopped engine. The CMV state assumes the value CMV=1 and the VSRA variable is reset to VSRA=0, because the intake throttle actuation function is no longer active, the intake throttle is thus vibrated free.

At time t3, the time period tLA, for example tLA=2 weeks, is expired. The time period tLA defines the temporally recurring setting of the intake throttle actuation function. At time t3, therefore, the intake throttle actuation function is set again. At time t6, a running internal combustion engine is detected because the engine rotational speed nMOT>80 1/min In FIG. 5B, the MSS signal changes to MSS=0. This leads to the event that the time variable ta, which effects the setting of the intake throttle actuation function after expiration of the time period tLA, is reset. At time t7, a running internal combustion engine is detected, i.e., in FIG. 5B the MSS signal changes to the value MSS=1. At this point, the time variable ta starts again. At time t8, the time period tLA is expired, so that the intake throttle actuation function is set again. The internal combustion engine is still stopped. MSS=1 thus applies (FIG. 5B). At time t11, the intake throttle is actuated again because in this case as well the time period tLA is again expired. Correspondingly, at time t14 the intake throttle actuation function is set again and the intake throttle is vibrated loose. At this point, the internal combustion engine is detected as running at time t16, at active state CMV=3, prior to ending the intake throttle actuation function. This has the consequence that the intake throttle actuation function is immediately ended, i.e., the state assumes the value CMV=1, the actuation current iVSR is set to the value iVSR=0 A, the periodic time TPWM is set to the base periodic time T1, and the VSRA variable is set to the value VSRA=0. At time t17, a stopped internal combustion engine (MSS=1) is detected again. At this point, the time variable to starts again such that following expiration of the time period tLA at time t18, the intake throttle actuation function is implemented again.

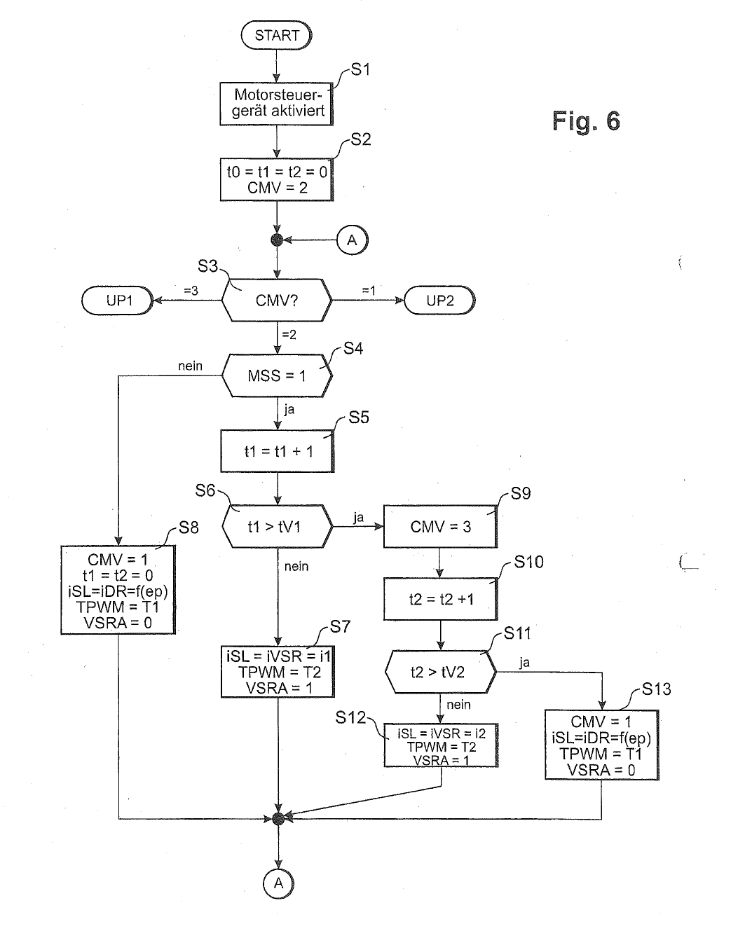

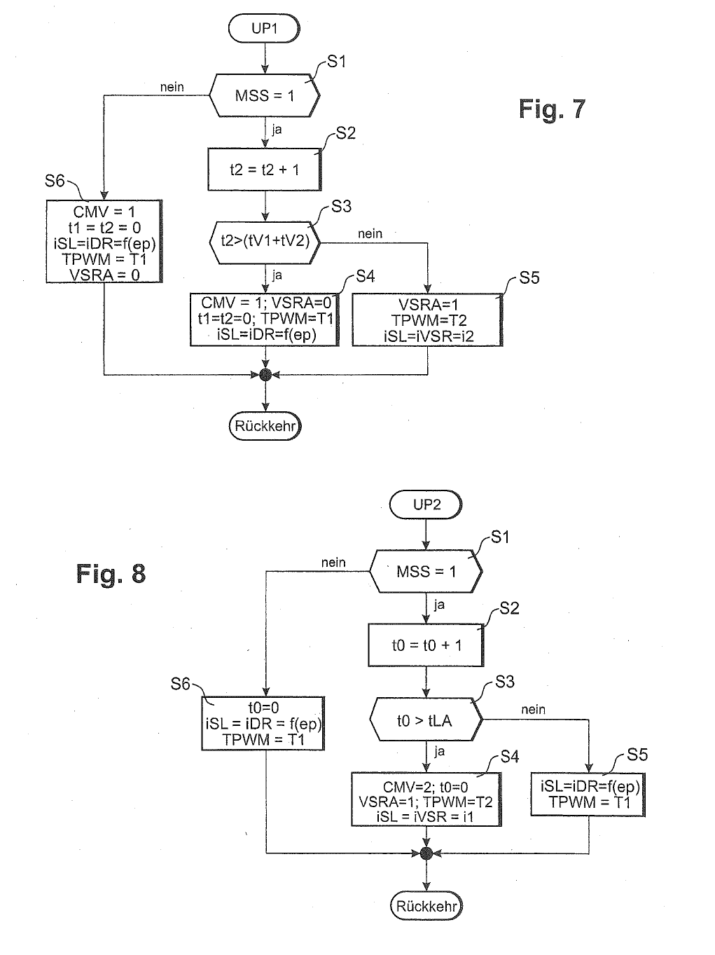

FIG. 6 shows a flow chart for converting the intake throttle actuation function in the case of normal operation. At S1, the electronic engine control unit is switched on, which subsequently has the result that, in step S2, the time variables t0, t1, and t2 are set to zero. Supplementally the second state (FIG. 4: 20) is set. CMV=2 thus applies. Afterwards, at S3, the state of the transition diagram (FIG. 4) is queried. If the state CMV=3 is set, then a first subroutine UP1 is activated, which is explained in connection with FIG. 7. If the state CMV=1 is set, then a second subroutine UP2 is activated, which is explained in connection with FIG. 8. If the state assumes the variable CMV=2, then S4 queries whether a stable engine idle time MSS is detected. If this is not the case, result of the query S4: no, then S8 is implemented. At S8, the state variable CMV is set to the value CMV=1, the time variable to t1=0, and the time variable to t2=0. Likewise at S8, the target current iSL is set to a pressure regulator current iDR depending on the rail pressure control deviation ep, the periodic time TPWM is set to the base periodic time T1, and the VSRA variable to VSRA=0.

If, in contrast, a stopped engine is detected at S4, result of query S4: yes, then at S5 the time variable t1 is incremented. Afterwards, at S6, the time variable t1 is checked. If t1 is not greater than the adjustable interval tV1, result of query S6: no, then at S7 the target current iSL is set to the value of the actuation current iVSR via the intake throttle actuation function, the periodic time TPWM of the PWM signal to the adjustable variable T2, and the VSRA variable to VSRA=1. If, in contrast, the time variable t1 is greater than the first interval tV1, result of query S6: yes, then at S9 the state variable is set to CMV=3. Subsequently at S10, the time t2 is incremented and, at S11, checked whether this is greater than the second interval tV2. If the interval tV2 is not yet expired, result of query S11: no, then at S12 the actuation current iVSR, and thus the target current iSL, is set to the value i2. Likewise, the periodic time TPWM of the PWM signal is set to the value T2, and the VRSA variable to VSRA=1. If the time variable t2 is greater than the second interval tV2, then S13 is implemented. The state variable CMV is set thereby to CMV=1, the target value iSL is set to the calculated pressure regulator value iDR, the periodic time TPWM to the base periodic time T1, and the VSRA variable to VSRA=0. Afterwards, the program sequence branches to point A, and thus again to S3.

FIG. 7 presents a first subroutine UP1. This is called up when the third state, thus CMV=3 is detected in the main program of FIG. 6. S1 queries whether an engine idle time is present (MSS=1). If this is not the case, result of query S1: no, then S6 is implemented. At S6, the state variable CMV is set to the value CMV=1, the time variable to t1=0, and the time variable to t2=0. Likewise at S6, the target current iSL is set to the calculated value of the pressure regulator current iDR depending on the rail pressure control deviation ep, the periodic time TPWM to the base periodic time T1, and the variable VSRA to VSRA=0. Afterwards, the first subroutine is ended and it branches to point A of the main program of FIG. 6.

If, in contrast, a stopped engine was detected at S1, then at S2 the time variable t2 is incremented. At this point, S3 checks whether the time variable t2 is greater than the sum of the first interval tV1 and the second interval tV2. If this is the case, result of query S3: yes, then S4 is implemented, which is identical to S6. If, in contrast, the query at S3 is negative, then S5 is implemented. At S5, the actuation current iVSR, and thus the target current iSL, is set to the value i2. Likewise, the periodic time TPWM of the PWM signal is set to the adjustable value T2, and the VSRA variable to VSRA=1. Afterwards, the first subroutine is ended and it returns to point A of the main program of FIG. 6.

FIG. 8 presents a second subroutine UP2. This is called up when the state CMV=1 is detected in the main program of FIG. 6. S1 queries whether an engine idle time is present. If this is not the case, result of query S1: no, then S6 is implemented. The time variable is thereby set to t0=0, the target current iSL is adjusted to the calculated pressure regulator current iDR, and the periodic time TPWM of the PWM signal to the base periodic time T1. Afterwards, the second subroutine UP2 is ended and it branches to point A of the main program of FIG. 6. If, in contrast, a stopped engine is detected at S1, then at S2 the time variable t0 is incremented. S3 subsequently checks whether the time variable t0 is greater than the first period tLA. If this is the case, result of query S3: yes, then at S4 the time variable is set to t0=0 and the second state is set. CMV=2 thus applies. Supplementally, the target current iSL is set to the value of the actuation current iVSR and thus to the first current value i1, the periodic time TPWM of the PWM signal to the value T2, and the VSRA variable to VSRA=1. If the time variable t0 is not greater than the time period tLA, then S5 is implemented. The target current iSL is thereby set to the value of the pressure regulator current iDR, which in turn is calculated from the pressure regulator depending on the rail pressure control deviation ep. Supplementally, at S5 the periodic time TPWM of the PWM signal is adjusted to the base periodic time T1. Afterwards the second subroutine UP2 is ended and it branches back to point A of the main program of FIG. 6.

1. A method for closed-loop control and open-loop control of an internal combustion engine having a common rail system, in which rail pressure (pCR) is determined in that an electronic engine control unit specifies a flow rate of a high-pressure pump into a rail via an intake throttle on a low-pressure side, the method comprising:
an intake throttle actuation function, by which the intake throttle is temporarily actuated, is set to recur over time in the case of known idle time (MSS) of the internal combustion engine and an actuated engine control unit.

2. The method according to claim 1,
wherein the intake throttle actuation function is set for the first time in an initialization phase (INIT) of the engine control unit.

3. The method according to claim 2,
wherein the intake throttle is actuated in a closed direction when the intake throttle actuation function is set.

4. The method according to claim 3,
wherein a pulse width modulating signal (PWM) for controlling the intake throttle is set to a PWM actuation value (PWMA) via the intake throttle actuation function, or an electrical target current (iSL) is set to an electrical actuation current (iVSR) via the intake throttle actuation function.

5. The method according to claim 4,
wherein a periodic time (TPWM) of the PWM signal is simultaneously set to an actuation time (T2).

6. The method according to claim 5,
wherein the PWM actuation value (PWMA) or alternately the actuation current (iVSR) are specified incrementally over time.

7. The method according to claim 1,
wherein an idle state (MSS) of the internal combustion engine is detected if an engine rotational speed (nMOT) is stably lower than a rotational speed threshold.

8. The method according to claim 1,
wherein the intake throttle actuation function is interrupted if the internal combustion engine is started.

9. The method according to claim 8,
wherein an engine start is detected if an engine rotational speed (nMOT) is greater than a rotational speed threshold or an injection is activated.
